(19) United States
(12) Patent Application Publication
(10) Pub. No.: US 2024/0083612 A1
(43) Pub. Date: Mar. 14, 2024

(54) DEVICE AND METHOD FOR FILLING BAGS

(71) Applicant: Harro Höfliger Verpackungsmaschinen GmbH, Allmersbach im Tal (DE)

(72) Inventor: Jörg ROSENLAND, Auenwald (DE)

(73) Assignee: Harro Höfliger Verpackungsmaschinen GmbH, Allmersbach im Tal (DE)

(21) Appl. No.: 18/465,271

(22) Filed: Sep. 12, 2023

(30) Foreign Application Priority Data
Sep. 13, 2022 (EP) 22195250.0

(51) Int. Cl. B65B 39/00; B65B 3/00; B65B 51/14

(52) U.S. Cl. CPC B65B 39/00; B65B 3/003; B65B 51/146

(57) ABSTRACT

A device (10) for filling a bag (12) with a liquid has a holder (16) for a bag (12) and a dosing needle (14), which can be inserted into a connection element (22) of the bag (12). A sealing clamp (40) is used to press the connection element (22) from the outside against the dosing needle (14) during filling.

### CROSS-REFERENCE TO RELATED APPLICATION

This application claims priority of European Patent Application 22195250.0, filed on Sep. 13, 2022, the contents of which is incorporated by reference in its entirety.

### TECHNICAL FIELD

The disclosure relates to a device and a method for filling bags, in particular for filling infusion bags with a liquid. Infusion bags can be bags with only one chamber, but they can also be multi-chamber bags. Multi-chamber bags can also comprise, for example, a powder and a liquid chamber.

### BACKGROUND

Infusion bags must generally be filled under special conditions (referred to as “low bioburden”) since the contents of infusion bags are supplied to a patient and must therefore not be contaminated. In the case of oxygen-sensitive contents, particularly in the case of cancer drugs or in the case of infusions for parenteral nutrition, it may be necessary to fill the infusion bags under inert gas since the liquid to be introduced must not come into contact with atmospheric oxygen. Nitrogen is typically used as the inert gas in this case. For some contents, sterilization after filling is possible. In this case, an aseptic production process is not required. If, on the other hand, subsequent sterilization is not possible, an aseptic production process must be carried out.

Infusion bags usually have a filling hose, via which the filling of the bags can take place. For this purpose, a dosing needle is inserted into the filling hose. The dosing needle usually has at least one contour feature on its outer contour, by means of which the flexible filling hose is widened from the inside. The filling hose then seals itself against the dosing needle by virtue of its internal stress. Such sealing of the filling hose against the dosing needle is necessary to ensure that no liquid can get between the dosing needle and the filling hose during dosing. During the filling of the bag, counter forces may occur. Therefore, the filling hose must be stretched at the contour features to such an extent that the forces of the material stress are greater than the forces of the liquid. When the filling hose is pulled off the dosing needle after the infusion bag has been completely filled, the filling hose is generally stretched to a relatively great extent lengthwise during this process. The filling hose then snaps back again. This can lead to the product being sprayed into the environment. Contamination of the inside of the filling hose is also possible.

To facilitate the removal of the filling hose from the dosing needle, push-type hose removers can be used. The push-type hose removers actively push the filling hose away from the dosing needle, reducing the risk of relatively large strains of the filling hose.

When filling the bags, it is important that there is no liquid in the end region of the filling hose. Liquid in the end region of the filling hose can make the subsequent closure of the bag more difficult. Moreover, the bag may leak, and this would lead to the rejection of the corresponding product.

In order to prevent the liquid present in the bag from being drawn into the filling hose after the end of the filling process, a brief post-gassing process can first be carried out. This is possible in principle if a dosing valve with connections both for the liquid and for an inert gas is used. If, on the other hand, active post-gassing is to be dispensed with when dosing, some other way of ensuring that the dosing hose is ventilated must be adopted. This can be difficult, particularly in the case of filling by means of “single use” components.

### SUMMARY

The present disclosure provides an improved device and an improved method for filling bags which exhibits the best possible sealing of the bag against the dosing needle.

The improved device for filling a bag has a holder for a bag and a dosing needle which can be inserted into a connection element of the bag. There further is a sealing clamp, by means of which the connection element can be pressed from the outside against the dosing needle.

As a result, there are no stresses in the connection element, and therefore there is also no spray or other contamination as the connection element is pulled off from the dosing needle. The removal of the connection element is thereby made significantly easier.

The sealing clamp can preferably have a plurality of clamping jaws. The clamping jaws can be pressed from the outside against the connection element in order to seal it against the dosing needle. In this case, the clamping jaws can be controlled individually, allowing adaptation to different sizes of connection elements. The number of clamping jaws can be freely chosen according to the material of the connection element and the respective size of the connection element. By replacing the clamping jaws with alternative clamping jaws, adaptation to different bags and dosing needles can be accomplished in a simple and rapid manner.

In a particularly advantageous embodiment, the outside diameter of the dosing needle can be somewhat smaller than the inside diameter of the connection element. After the release of the sealing clamp, an air gap can thus be formed between the dosing needle and the connection element. This enables air to flow into the bag while the connection element is being pulled off, making it significantly easier to pull the connection element off.

The connection element of the bag can preferably be designed as a filling hose.

In the method for filling a bag with a liquid, a dosing needle is first introduced into a connection element of a bag. The connection element is then pressed from the outside against the dosing needle, with the result that the connection element is sealed against the dosing needle. As soon as sealing has taken place, the bag can be filled.

The seal between the connection element and the dosing needle can preferably be broken after the filling of the bag. As a result, an air gap can again form between the dosing needle and the connection element, through which air can flow into the bag. It is thereby possible to facilitate the pulling off of the connection element from the dosing needle.

After the dosing needle has been removed, the connection element can be closed, in particular sealed. Alternatively, closure by means of a stopper, for example, is also possible.

### BRIEF DESCRIPTION OF THE DRAWINGS

The invention is described and explained in greater detail below with reference to the exemplary embodiment illustrated in the drawing.

FIG. 1 shows a cross section through a device for filling a bag before the connection element is sealed against the dosing needle.

FIG. 2 shows a cross section according to FIG. 1 during the sealing of the connection element against the dosing needle.

### DETAILED DESCRIPTION

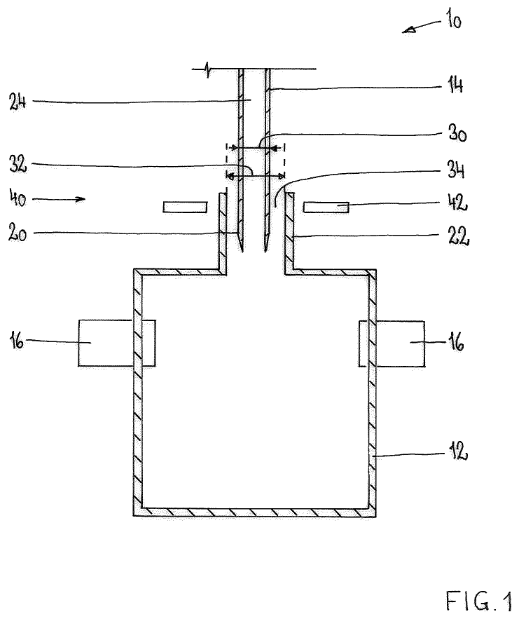

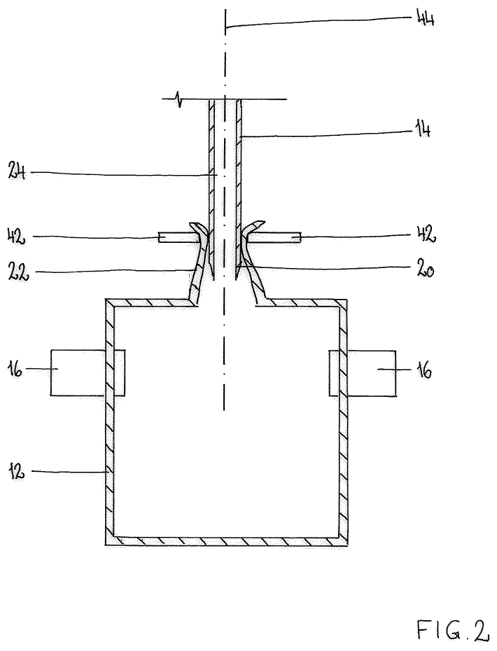

A device 10 for filling bags 12 is shown in FIGS. 1 and 2. In the illustrated example, the bag 12 is designed as an infusion bag. The device 10 has a dosing needle 14 and a holder 16 for the infusion bag 12. The free end 20 of the dosing needle 14 can be inserted into a connection element 22 of an infusion bag 12, enabling liquid to be introduced into the infusion bag 12 through the interior 24 of the dosing needle 14. In the illustrated example, the connection element 22 of the infusion bag 12 is designed as a filling hose.

The dosing needle 14 can be fastened via a connecting flange (not shown here) to a filling device (not shown here), in particular to a filling head. Fastening can preferably be effected by means of one or more screws. In the case of single-use dosing equipment, the filling hose of the bag 12 can also be plugged directly onto the filling head of the filling device. In this case, the filling head of the filling device serves as a dosing needle 14.

In the illustrated example, the dosing needle 14 has an approximately circular cross section. In principle, the cross-sectional shape of the dosing needle 14, in particular of the free end 20 of the dosing needle 14, is a matter of free choice in the device 10. It is thereby possible to adapt the free end 20 of the dosing needle 14 to different connection elements 22 of an infusion bag 12 and to different cross-sectional shapes of the connection elements 22 of an infusion bag 12. The dosing needle 14 can therefore also have a rectangular, a square or an oval cross section, for example.

In order to fill the infusion bag 12, the free end 20 of the dosing needle 14 can be inserted a certain distance into the filling hose 22. In this case, the outside diameter 30 of the dosing needle 14 is somewhat smaller than the inside diameter 32 of the filling hose 22. Preferably, the outside diameter 30 of the dosing needle 14 is between 80% and 95% of the inside diameter 32 of the filling hose 22. As a result, a small air gap 34 is formed between the dosing needle 14 and the filling hose 22. After the infusion bag 12 has been filled, additional air can flow into the infusion bag 12 through this air gap 34, enabling the filling hose 22 to be removed from the dosing needle 14 without problems. In addition, the dosing needle 14 can also be introduced into the filling hose 22 simply and reliably through the air gap 34.

In order to seal the filling hose 22 against the dosing needle 14, a sealing clamp 40 having a plurality of clamping jaws 42 is provided in the region of the filling hose 22. The clamping jaws 32 can be adjusted perpendicularly to the longitudinal direction 44 of the dosing needle 14, with the result that the clamping jaws 32 press from the outside against the filling hose 22 during the actual filling process (see FIG. 2), thus ensuring that the filling hose 22 rests tightly against the outside of the dosing needle 14. The filling hose 22 is thus sealed against the dosing needle 14.

After the end of the filling process, the clamping jaws 32 are released again, with the result that the air gap 34 is once again formed between the dosing needle 14 and the filling hose 22. The infusion bag 12 can then be removed from the dosing needle 14 and closed. For this purpose, the infusion bag 12 can, in particular, be sealed or closed by means of a stopper, for example.

What is claimed is:

1. A device (10) for filling a bag (12) with a liquid, comprising:
a holder (16) for the bag (12);
a dosing needle (14), which can be inserted into a connection element (22) of the bag (12); and
a sealing clamp (40) configured to press the connection element (22) from its outside against the dosing needle (14).

2. The device according to claim 1,
wherein the sealing clamp (40) has a plurality of clamping jaws (42).

3. The device according to claim 1,
wherein an outside diameter (30) of the dosing needle (14) is smaller than an inside diameter (32) of the connection element (22).

4. The device according to claim 1,
wherein the connection element (22) of the bag (12) is a filling hose.

5. A method for filling a bag (12) with a liquid, comprising:
inserting a dosing needle (14) into a connection element (22) of the bag (12);
pressing the connection element (22) from its outside against the dosing needle (14), thereby sealing the connection element (22) against the dosing needle (14); and
filling the bag (12).

6. The method according to claim 5, further comprising
breaking the seal between the connection element (22) and the dosing needle (14) after the bag (12) has been filled.

7. The method according to claim 6, further comprising
removing the dosing needle (14) from the connection element (22) after the seal between the connection element (22) and the dosing needle (14) has been broken.

8. The method according to claim 7, further comprising
closing the connection element (22) after removing the dosing needle (14).

9. The method according to claim 5,
wherein the connection element (22) of the bag (12) is a filling hose.
